(19) United States
(12) Patent Application Publication
(10) Pub. No.: US 2005/0083321 A1
(43) Pub. Date: Apr. 21, 2005

(54) Shared select line display

(75) Inventor: Willem den Boer, Hillsboro, OR (US)

Correspondence Address: KOLISCH HARTWELL, P.C., 520 S.W. YAMHILL STREET, SUITE 200, PORTLAND, OR, 97204, US

(73) Assignee: ScanVue Technologies LLC

(21) Appl. No.: 10/966,974

(22) Filed: Oct. 15, 2004

Related U.S. Application Data
(60) Provisional application No. 60/512,032, filed on Oct. 17, 2003.
(60) Provisional application No. 60/527,128, filed on Dec. 5, 2003.
(60) Provisional application No. 60/560,431, filed on Apr. 7, 2004.

(51) Int. Cl. G09G 3/36

(52) U.S. Cl. 345/204

(57) ABSTRACT

A progressive scan display including a matrix of pixels arranged in a plurality of pixel rows and pixel columns. For each pixel row, the display includes a pair of select lines configured to selectively allow video data to be loaded to pixels of that pixel row. For each pixel column, the display includes a data line configured to selectively load video data to pixels of that pixel column. At least one select line for each row of pixels is a shared select line configured to selectively allow video data to be loaded to two different pixel rows.

### CROSS-REFERENCES

This application claims the benefit of U.S. Provisional Application Nos. 60/512,032, filed Oct. 17, 2003, 60/527,128 filed Dec. 5, 2003, and 60/560,431, filed Apr. 7, 2004, each of which is incorporated by reference.

### BACKGROUND

Many devices now include displays for presenting visual information. In general, a display has several attributes that affect its suitability for a particular purpose. Among these attributes are size, brightness, resolution, clarity, and energy consumption. Display sizes can range from between less than an inch to a few inches diagonal viewing area for handheld devices, such as cellular telephones and portable televisions, to between tens or hundreds of feet for stadium displays. Depending on the desired viewing area for a particular display application, various technologies may be more suitable than others.

### BRIEF DESCRIPTION OF THE DRAWINGS

FIG. 1 shows an exemplary differentiating circuit.

FIG. 2 shows an embodiment of the differentiating circuit of FIG. 1.

FIG. 3 shows a portion of an exemplary duel select diode matrix utilizing dedicated select lines.

FIG. 4 shows a portion of an exemplary duel select diode matrix utilizing shared select lines.

FIG. 5 shows exemplary drive waveforms for driving a duel select diode matix that utilizes shared select lines.

FIG. 6 shows a table corresponding to the drive waveforms of FIG. 5.

FIG. 7 shows a pixel of an exemplary duel select diode matrix that utilizes dedicated select lines with data lines located off of an active matrix array.

FIG. 8 shows a pixel of an exemplary duel select diode matrix that utilizes shared select lines with the data lines located off of an active matrix array.

### DETAILED DESCRIPTION

Active matrix liquid crystal displays are widely used in a variety of applications, including notebook computers, flat panel monitors, handheld computers, cellular phones, and flat panel televisions. Active matrix liquid crystal displays may be fabricated by depositing and patterning various metals, insulators, and semiconductors on substrates. Such displays commonly employ semiconductor devices, such as amorphous silicon (a-Si) thin film transistors. Each pixel in the active matrix liquid crystal display may be coupled to an address transistor, which controls the voltage on each pixel and therefore its transmittance.

A growing application for active matrix liquid crystal displays is in large area televisions, which may have a diagonal size of up to 50 inches or more. However, thin film transistor controlled pixel arrays are difficult to manufacture for this application since a relatively large number of process steps are required to construct the thin film transistors. The total mask count may be 5 or 6 or more, which is burdensome. While the yields for small displays can be quite high, it is difficult to obtain an acceptable yield for large area displays. In addition, the design rules for patterning the various insulator, metal, and semiconductor layers are the same for small and large thin film transistor liquid crystal displays, requiring expensive photo-exposure equipment for large area substrates. This all increases the manufacturing expense of such thin film transistor liquid crystal displays.

Nonlinear resistors can be used in place of transistors in a display circuit. A nonlimiting example of a nonlinear resistor is a thin film diode. Thin film diodes, including those referred to as metal-insulator-metal diodes, can be more economical to fabricate than a-Si thin film transistors. When a single thin film diode is used in series with a liquid crystal pixel, any variation in the thin film diode characteristic across the display area or over time or temperature can lead to a variation in the pixel voltage. This can result in poor gray scale control, poor uniformity, slow response time, and/or image sticking. In addition, it is difficult, if not impossible, to scale up single thin film diode liquid crystal displays to a diagonal size larger than about 10 inches without severe brightness gradients.

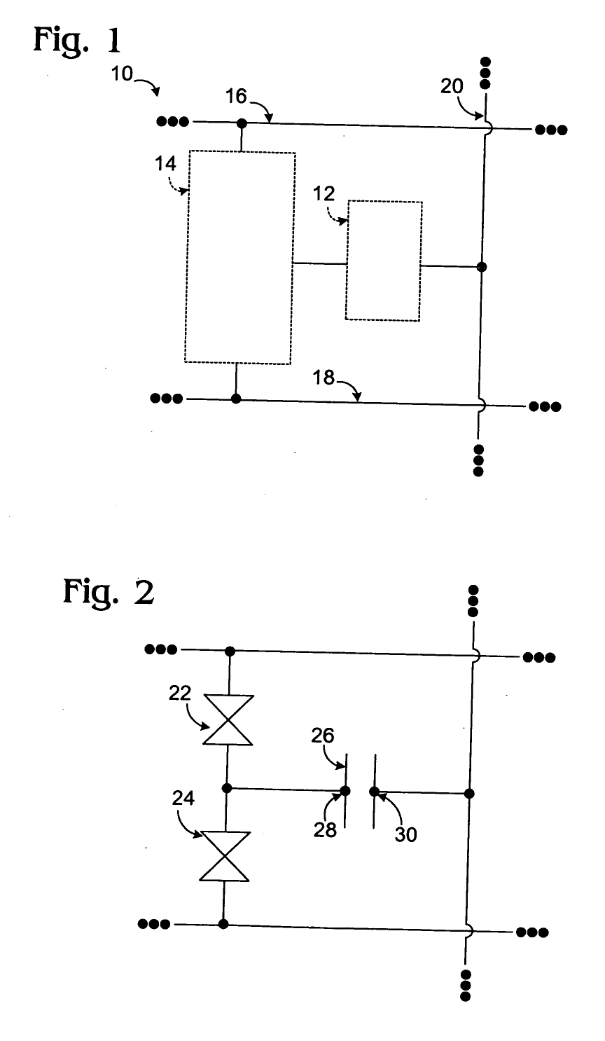

However, a differential circuit may mitigate, if not eliminate, the drawbacks of the single thin film diode approach. FIG. 1 shows an exemplary differential circuit 10, which includes a light-producing module 12 and a differentiating module 14. The circuit also includes select line 16 and select line 18, which are operatively connected to different nodes of differentiating module 14. The circuit also includes a data line 20 that is operatively connected to the light-producing module. As shown in FIG. 2, a differentiating module can include a pair of nonlinear resistors, such as bidirectional diode 22 and bidirectional diode 24. The light producing module can include a capacitor 26 having a pixel node 28 that is operatively connected to different select lines by way of a differentiating module. The capacitor also may include a data node 30 that is operatively connected to a data line. The light producing module may include an exit polarizer configured to modulate light output responsive to the relative charge of the capacitor. U.S. Pat. Nos. 4,731,610, 6,222,596, 6,225,968, and 6,243,062 describe exemplary arrangements that utilize a differential circuit, and are hereby incorporated herein by reference. Such displays are herein referred to as dual select diode displays.

The fabrication of a dual select diode matrix array for active matrix liquid crystal displays can be achieved in only two or three mask steps, with relaxed design rules that scale with the display size. When operated in a dual select mode, the pixel circuit can act as an analog switch. The dual select diode circuit is not a two-terminal switching device, but rather a three-terminal switching device similar to a circuit utilizing thin film transistors. A dual select diode circuit can perform comparably to a thin film transistor liquid crystal display as a result of accurate gray scale control, fast response time, and tolerance for variations in thin film diode characteristics over time and across the viewing area. Such a dual select diode liquid crystal display also can be relatively insensitive to RC delays on the select and data lines and can therefore be scaled up to very large area, for example, exceeding 40 inches in diagonal size.

FIG. 3 shows a portion of pixel row Rᵢ and adjacent pixel row Rᵢ₊₁ of a dual select diode circuit in which each row of pixels is associated with a pair of dedicated select lines. Pixel row Rᵢ is operatively connected to dedicated select lines Sᵢ and Sᵢ₊₁, which are configured to address only row Rᵢ. Similarly, pixel row Rᵢ₊₁ is operatively connected to dedicated select lines Sᵢ₊₂ and Sᵢ₊₃, which are configured to address only Rᵢ₊₁. Dedicated select lines in a duel select diode display, and the spacing between the dedicated select lines, can take up a substantial percentage of the total area of a display. This can reduce the percentage of pixel opening, and therefore the brightness of the display when a backlight is used. In other words, a duel select diode display that dedicates two select lines per row may require more energy and/or be less bright than a display that does not dedicate two select lines per row. For portable applications, such as cellular phones and digital cameras, the energy consumption of the display directly affects battery life, and therefore improvements in brightness efficiency can lead to improvements in battery life. By increasing the effective size of a pixel opening, the brightness can be maintained with relatively less energy consumption, thus improving battery life. Furthermore, displays that do not dedicate two select lines per row may be less likely to experience shorts between immediately adjacent select lines. Such shorts may have an impact on the manufacturing yield. Displays that do not dedicate two select lines per row can be operated with fewer row driver outputs and row driver interconnects, further improving manufacturing ease, yield, and expense.

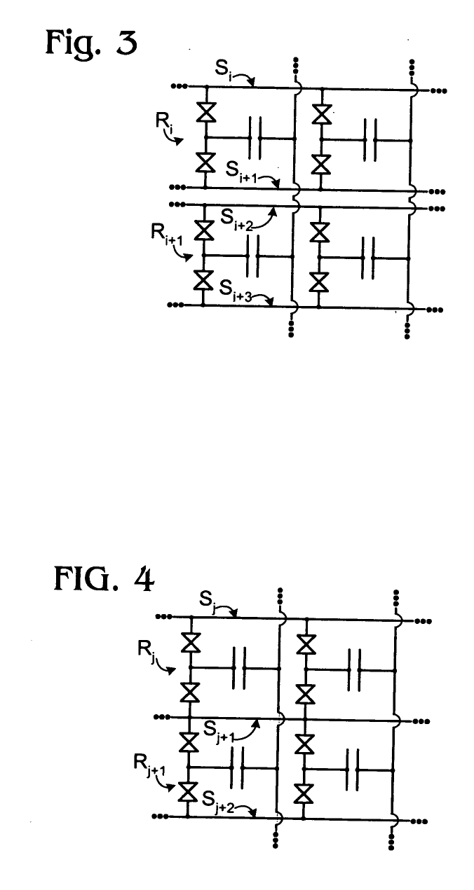

FIG. 4 shows a portion of pixel row Rⱼ and adjacent pixel row Rⱼ₊₁ of a dual select diode circuit in which each row of pixels is associated with a pair of shared select lines. Pixel row Rⱼ is operatively connected to select lines Sⱼ and Sⱼ₊₁, and pixel row Rⱼ₊₁ is operatively connected to select lines Sᵢ₊₁ and Sᵢ₊₂. Select line Sᵢ₊₁ is a shared select line that can be used to progressively address row Rⱼ and adjacent pixel row Rⱼ₊₁. By sharing select lines, the total number of select lines can be reduced from 2x to x+1, where x equals the number of rows of a display. For example, a display having 720 rows of pixels would have 1440 select lines in a system that uses dedicated select lines and could have only 721 select lines in a system that uses shared select lines. In addition to decreasing the number of select lines and associated drivers and interconnects, the space between adjacent dedicated select lines is eliminated, because adjacent dedicated select lines are consolidated into a shared select line. Therefore, the distance between adjacent pixel openings can be decreased significantly, and the pixel aperture can be increased, compared to a pixel that uses dedicated select lines, without increasing the footprint of the pixel on the display. Pixel aperture can be increased 70% or more. This can increase the display brightness and/or energy efficiency.

A dual select diode circuit utilizing shared select lines can perform approximately equivalent to a dual select diode circuit utilizing dedicated select lines. As described by nonlimiting example below, for each row of pixels, overlapping select pulses having opposite polarity can be driven through the shared select lines corresponding to that row of pixels. Furthermore, the polarity of a column data line can be controlled over time so as to have the same polarity as the select pulse of the first in time of the corresponding row select lines. As shown below, the data line can be controlled so as to alternate polarity between selection of each successive row of select lines.

In general, a display can be addressed one row at a time by progressively scanning the rows. Opposite polarity select pulses can be applied to two adjacent select lines which address a particular row of pixels. The duration of the opposite polarity select pulses can be set to about twice the line time, so that the select pulses of subsequent rows overlap by about one line time. In addition, the polarity of the data pulse can be inverted every line time to obtain a row inversion (line inversion) drive scheme. When the polarity of the data pulse is set the same as the polarity of the first in time of the two select pulses applied to a row, the operation of the pixel is similar to a conventional duel select diode circuit that utilizes dedicated select lines. The duel select diode circuit with shared select lines can act as an analog switch, which results in the accurate charging of the pixel to the desired gray level. When the next row of pixels is selected, one of the two select pulses for the previous row can be left active for one more line time. However, due to the row inversion drive scheme, the diodes connected to this select line are not fully switched on and will therefore not discharge the pixels on the previous row. Circuit simulations demonstrate that this leads to accurate gray scale performance.

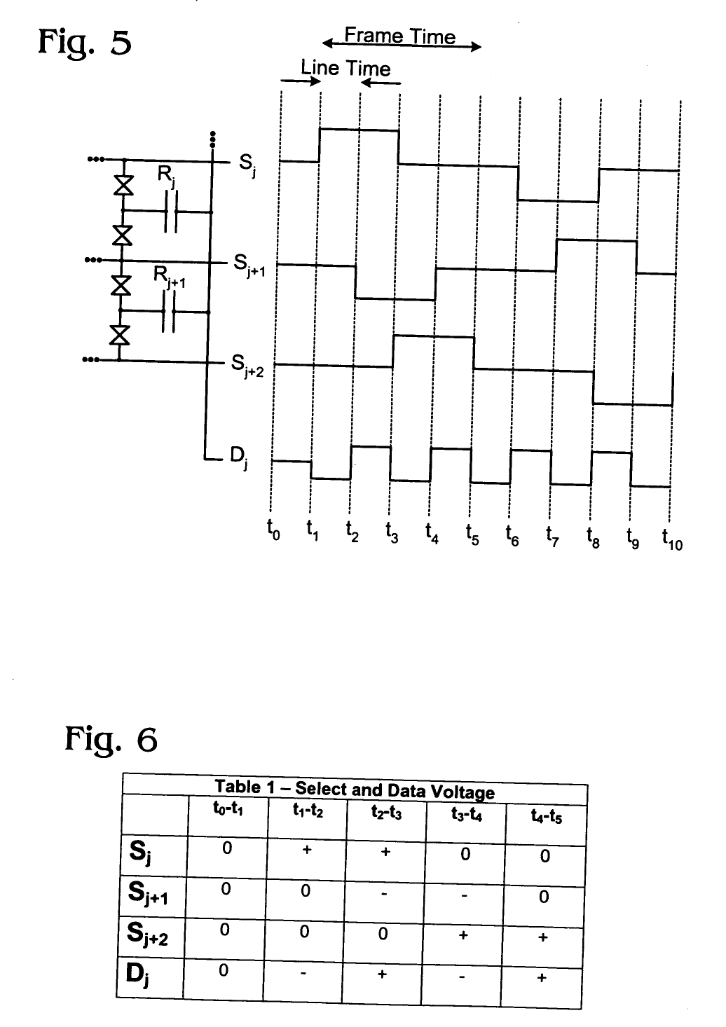

FIG. 5 shows two pixels of an exemplary dual select diode circuit in which pixels in adjacent rows Rⱼ and Rⱼ₊₁ share a common select line. FIG. 5 also shows corresponding drive waveforms for selecting the pixel rows and providing video data to the individual pixels. Such waveforms can be applied by a scan controller and/or data controller. FIG. 6 is a table corresponding to the exemplary drive waveforms of FIG. 6. The drive wave forms shown in FIGS. 5 and 6 correspond to select lines Sⱼ, Sⱼ₊₁, Sⱼ₊₂, and data line Dⱼ. For the purpose of simplicity, this example is provided with reference to only two pixels of a display which can be virtually any size.

As illustrated, row Rⱼ is the pixel row between select lines Sⱼ and Sⱼ₊₁, and row Rⱼ₊₁ is the pixel row between select lines Sⱼ₊₁ and Sⱼ₊₂. Select line Sⱼ₊₁ is between row Rᵢ and row Rⱼ₊₁ and can be used to address either row. In other words, select line Sⱼ₊₁ is a shared select line that is not dedicated to addressing only one row of pixels. In general, each interior select line will service two adjacent rows of pixels. The times t₀, t₁, t₂, t₃, t₄ and t₅ denote times when changes are made to the voltages of the select lines.

During the period before t₂, row Rⱼ and row Rⱼ₊₁ are deselected. At t₁ a positive voltage is applied to select line Sⱼ. At t₂ a negative voltage is applied to select line Sⱼ₊₁, thus select voltages having opposite polarities are present at the select lines addressing row Rⱼ. The opposite polarities of select line Sⱼ and select line Sⱼ₊₁ cause row Rⱼ to be selected. The voltage on the active pixel electrodes of row Rⱼ are reset to the center voltage between the two opposite polarity select voltages. The pixels of row Rⱼ can be accurately charged to the data voltage, which can be applied with the same polarity as the voltage applied to select line Sⱼ. Operation during this interval is similar to that of a duel select diode circuit that utilized dedicated select lines.

At t₃ a positive voltage is applied to select line Sⱼ₊₂. Because select line Sⱼ₊₁ continues to receive a negative voltage, select voltages having opposite polarities are present at the select lines addressing row Rⱼ₊₁. Thus, row Rⱼ₊₁ is selected. The pixels on row Rⱼ₊₁ can be accurately charged to an applied data voltage. The data voltage can be applied with the same polarity as the voltage applied to select line Sⱼ₊₁. Although select line Sⱼ₊₁ is still activated, substantial charge will not leak from the pixels of row Rⱼ. Because of the data polarity change from row Rⱼ to row Rⱼ₊₁, the voltages on the pixel electrodes of row Rⱼ change towards the voltage of select line Sⱼ₊₁. The voltage difference between the pixels on row Rⱼ and select line Sⱼ₊₁ is not sufficient to cause substantial charge leakage through the pixel diode adjacent select line Sⱼ₊₁ during the line time interval between t₃ and t₄.

In the interval between t₄ and t₅, both rows are deselected. Although a positive voltage is still being applied to select line Sⱼ₊₂, substantial charge will not leak from the pixels of row Rⱼ₊₁. Because of the data polarity change from row Rⱼ₊₁ to a row Rⱼ₊₂ (not shown in FIG. 5), the voltages on the pixel electrodes of Rⱼ₊₁ change towards the voltage of select line Sⱼ₊₂. The voltage difference between the pixels on Rⱼ₊₁ and select line Sⱼ₊₂ is not sufficient to cause substantial charge leakage through the pixel diode adjacent select line Sⱼ₊₂ during the line time interval between t₄ and t₅.

As shown in FIG. 5, during the next frame, all select pulses and data pulses are applied with the opposite polarity in order to obtain an AC drive for the pixel. A similar reversal of applied polarity can be repeated throughout each frame.

If the direction of scanning the display is always the same (e.g. from top to bottom), one diode branch at each pixel sees the majority of the current while the other diode is primarily used to balance the pixel voltage. Some of the advantages of the dual select diode circuit, such as insensitivity to diode degradation and non-uniformity, may be lost When the direction of scanning remains the same. To prevent one set of diodes in each row from constantly carrying larger currents than the other set, the direction of scanning can be reversed periodically. The scan direction may be reversed for circuits utilizing dedicated select lines or circuits utilizing shared select lines.

For example, the initial sequence for selecting the rows in a display with N rows may be: Row₁, Row₂, Row₃, . . . Row_{N}. The sequence may be changed to: Row_{N}, Row_{N-1}, Row_{N-2}, . . . Row₁. Such a change in sequence may be initiated in response to an event, such as reaching a predetermined operating time (5 minutes, 30 minutes, etc.), every time the display is turned on, at the change of a scene in a video image, or upon virtually any other predetermined event. A display system may include a frame buffer to store at least one frame of video data so that the sequence can be reversed at any time without dropping a frame of video. Such buffers can be used on small displays for cell phones, PDAs, and the like, or on relatively large displays for televisions and other monitors.

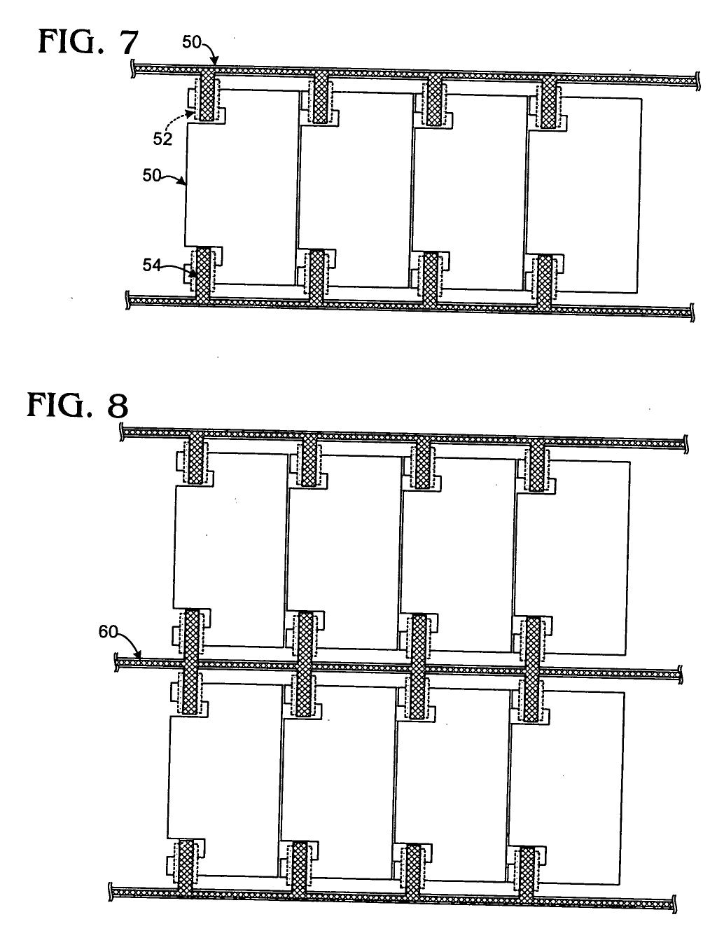

In some embodiments, data lines can be located off of the active matrix array. As a nonlimiting example, the data lines can be implemented as indium-tin-oxide stripes on the opposite substrate (the color plate). The absence of data lines on the active matrix array facilitates spacing the color sub-pixels very close to each other when a vertical stripe color filter arrangement is used. FIG. 7 shows four color sub-pixels arranged in vertical stripe orientation. Displays with four color sub-pixel arrangements can have up to 50% higher brightness than displays with three color sub-pixel arrangements using data lines on the active matrix array. A four color sub-pixel arrangement can be fabricated in three steps. In each step, a different material can be layered in the desired pattern. As a nonlimiting example, a first layer 50 can include indium-tin-oxide, a second layer 52 can include silicon nitride (SiNₓ), and a third layer 54 can include a metal or another suitable conductor. As shown in FIG. 8, a four color sub-pixel arrangement can be fabricated with a shared select line 60.

Although the present disclosure has been provided with reference to the foregoing operational principles and embodiments, it will be apparent to those skilled in the art that various changes in form and detail may be made without departing from the spirit and scope defined in the appended claims. The present disclosure is intended to embrace all such alternatives, modifications and variances. Where the disclosure or claims recite “a,” “a first,” or “another” element, or the equivalent thereof, they should be interpreted to include one or more such elements, neither requiring nor excluding two or more such elements.

1. A circuit comprising:
a first capacitor having a pixel node and a data node;
a first nonlinear resistor operatively connected to the pixel node of the first capacitor;
a second nonlinear resistor operatively connected to the pixel node of the first capacitor;
a second capacitor having a pixel node and a data node;
a third nonlinear resistor operatively connected to the pixel node of the second capacitor;
a fourth nonlinear resistor operatively connected to the pixel node of the second capacitor;
a first select line operatively connected to the first nonlinear resistor;
a second select line operatively connected to the second nonlinear resistor and the third nonlinear resistor; and
a third select line operatively connected to the fourth nonlinear resistor.

2. The circuit of claim 1, further comprising a progressive scan controller configured to progressively address the select lines.

3. The circuit of claim 2, wherein the progressive scan controller is configured to selectively reverse a scan direction.

4. The circuit of claim 2, wherein the progressive scan controller is configured to:
apply a select voltage to the first select line;
apply an opposite-polarity select voltage to the second select line, thereby selecting a first row of pixels including the first capacitor; and
apply a select voltage to the third select line and cease applying a select voltage to the first select line, thereby selecting a second row of pixels including the second capacitor and deselecting the first row of pixels.

5. The circuit of claim 1, further comprising a data controller configured to apply a data signal to the data node.

6. The circuit of claim 5, wherein the circuit is one of a plurality of circuits arranged in rows, and wherein the data controller is configured to alternate data signal polarity applied to data nodes in adjacent rows.

7. The circuit of claim 1, further comprising a data line operatively connected to the data node of the first capacitor and the data node of the second capacitor; wherein the data line and the select lines are configured to selectively charge the first capacitor and the second capacitor.

8. The circuit of claim 1, wherein the first capacitor is a constituent element of a first light-producing module and the second capacitor is a constituent element of a second light-producing module, wherein each of the first capacitor and the second capacitor is configured to control characteristics of light output via the light-producing module including that capacitor.

9. The circuit of claim 8, wherein the first light-producing module and the second light-producing module each includes an exit polarizer configured to modulate light output responsive to a relative charge of the capacitor included in that light-producing module.

10. The circuit of claim 1, wherein the nonlinear resistor includes a bidirectional diode.

11. A progressive scan display comprising:
a matrix of pixels arranged in a plurality of pixel rows and pixel columns;
for each pixel row, a pair of select lines configured to selectively allow video data to be loaded to pixels of that pixel row; and
for each pixel column, a data line configured to selectively load video data to pixels of that pixel column;
wherein at least one select line for each row of pixels is a shared select line configured to selectively allow video data to be loaded to two different pixel rows.

12. The progressive scan display of claim 11, wherein each pixel includes a differential module and a light-outputting module having a pixel node and a data node, wherein the data node is operatively connected to the data line associated with that pixel, and wherein the pixel node is operatively connected to the pair of select lines associated with that pixel via the differential module.

13. The progressive scan display of claim 12, wherein the light-outputting module of each of the plurality of pixels is configured to output light having characteristics determined by a relative charge of the light-outputting module.

14. The progressive scan display of claim 12, wherein the differential module includes a pair of nonlinear resistors, each nonlinear resistor operatively connecting the pixel node to a different one of the select lines.

15. The progressive scan display of claim 14, wherein each nonlinear resistor includes a bidirectional diode.

16. The progressive scan display of claim 11, further comprising a progressive scan controller configured to progressively address the .matrix of pixels via the select lines and a data controller configured to load video data to selected pixels via the data lines.

17. The progressive scan display of claim 16, wherein the data controller is configured to alternate data signal polarity applied to pixels in adjacent rows.

18. The progressive scan display of claim 16, wherein the progressive scan controller is configured to selectively reverse a scan direction.

19. A display comprising:
a matrix of pixels arranged in a plurality of rows;
a plurality of shared select lines, wherein each shared select line is configured to address at least two rows of pixels; and
a progressive scan controller configured to progressively address the plurality of shared select lines.

20. The display of claim 19, wherein each pixel includes a differential module and a light-outputting module.

21. The display of claim 20, wherein the differential module includes a pair of nonlinear resistors, each nonlinear resistor operatively connecting the capacitor to a different one of the plurality of select lines.

22. The display of claim 21, wherein each nonlinear resistor includes a bidirectional diode.

23. The display of claim 20, wherein the light-outputting module is configured to output light having characteristics determined by a relative charge of the light-outputting module.

24. The display of claim 19, further comprising a data controller configured to load video data to pixels in adjacent rows by inverting data signal polarity applied to pixels in adjacent rows.

25. The display of claim 19, wherein the progressive scan controller is configured to selectively reverse a scan direction.

26. A method of progressively addressing a matrix of dual select diode pixels, wherein the matrix of pixels includes a first row of pixels and a second row of pixels, and wherein the first row of pixels is operatively connected to a first select line and a second select line and the second row of pixels is operatively connected to the second select line and a third select line, the method comprising:
applying a select voltage to the first select line;
applying an opposite-polarity select voltage to the second select line, thereby selecting the first row of pixels; and
applying a select voltage to the third select line and ceasing to apply an opposite-polarity select voltage to the first select line, thereby selecting the second row of pixels and deselecting the first row of pixels.

27. The method of claim 26, wherein a first pixel of the first row includes a first nonlinear resistor, a second nonlinear resistor, and a capacitor having a pixel node and a data node, wherein the data node is operatively connected to a data line, and wherein the pixel node is operatively connected to the first select line via the first nonlinear resistor and to the second select line via the second nonlinear resistor.

28. The method of claim 27, wherein the capacitor is a constituent element of a light-producing module, and wherein the capacitor is configured to control characteristics of light output via the light-producing module.

29. The method of claim 28, wherein the light-producing module includes an exit polarizer configured to modulate light output responsive to a relative charge of the capacitor.

30. The method of claim 26, further comprising applying a data voltage to a first pixel in the first row of pixels when the first row of pixels is selected; and applying an opposite polarity data voltage to a second pixel, adjacent the first pixel, in the second row of pixels when the second row of pixels is selected.
